(19) United States
(12) Patent Application Publication
(10) Pub. No.: US 2003/0196007 A1
(43) Pub. Date: Oct. 16, 2003

(54) Device-resident driver system and method

(76) Inventor: John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 10/121,254

(22) Filed: Apr. 12, 2002

(51) Int. Cl. G06F 3/00

(52) U.S. Cl. 710/13

(57) ABSTRACT

A peripheral device comprising a memory. The peripheral device also comprises a driver stored in the memory and transferable to a computer. The driver is adapted to interface the peripheral device with the computer.

### TECHNICAL FIELD OF THE INVENTION

The present invention relates generally to the field of computer systems and, more particularly, to a device-resident driver system and method.

### BACKGROUND OF THE INVENTION

Peripheral devices, such as printers, scanners, facsimile devices, digital cameras, joysticks, keyboards, pointing devices, speakers, and mass storage and recording devices, generally require a driver to provide translation of information between the peripheral device and an operating system. The driver generally comprises a software product provided independently and remote from the peripheral device. For example, the driver often accompanies the peripheral device in the form of a compact disc or other data storage medium. The driver is generally stored to a computer by a user of the computer prior to activation of the peripheral device such that upon activation of the peripheral device, the computer recognizes the peripheral device and uses the corresponding driver to communicate with the peripheral device.

Providing a driver corresponding to a peripheral device, however, is generally costly and time consuming. For example, a driver must generally be created for each operating language of the peripheral device. Therefore, in addition to the engineering and manufacturing costs associated with creating each driver, each corresponding driver must then be identified, categorized, and tracked to ensure that the proper driver accompanies the corresponding peripheral device.

### SUMMARY OF THE INVENTION

In accordance with one embodiment of the present invention, a peripheral device comprises a memory. The peripheral device also comprises a driver stored in the memory and transferable to a computer. The driver is adapted to interface the peripheral device with the computer.

In accordance with another embodiment of the present invention, a method for device-resident driver installation comprises ascertaining a type of peripheral device and determining whether a driver resides in a memory of the peripheral device. The method also comprises transferring a copy of the driver from the peripheral device if the driver resides in the memory of the peripheral device.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating a device-resident driver system in accordance with an embodiment of the present invention;

FIG. 2 is a flow chart illustrating a device-resident driver method in accordance with an embodiment of the present invention; and

FIG. 3 is a flow chart illustrating a device-resident driver method in accordance with an embodiment of the present invention.

### DETAILED DESCRIPTION OF THE DRAWINGS

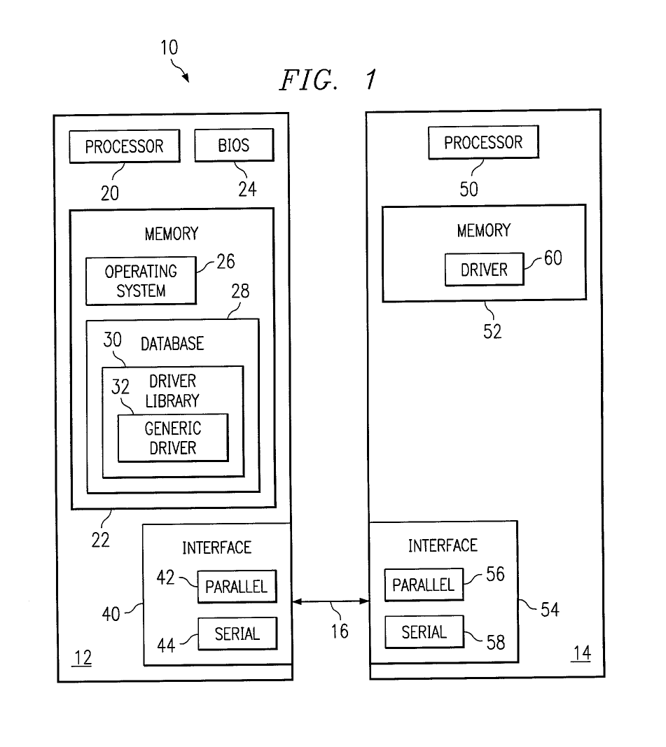

The preferred embodiments of the present invention and the advantages thereof are best understood by referring to FIGS. 1-3 of the drawings, like numerals being used for like and corresponding parts of the various drawings.

FIG. 1 is a diagram illustrating a device-resident driver system 10 in accordance with an embodiment of the present invention. In the illustrated embodiment, system 10 comprises a computer 12 and at least one peripheral device 14. Computer 12 may comprise any computing system or device such as, but not limited to, a workstation, desktop computer, server, or mainframe. Peripheral device 14 may comprise a printer, scanner, camera, pointing device, such a mouse or trackpad, keyboard, joystick, speaker system, facsimile device, mass data storage device, or other remotely-located or co-located device communicating with computer 12 via one or more wired or wireless communication networks 16. Briefly, a driver corresponding to peripheral device 14 is stored on peripheral device 14 such that computer 12 may retrieve a copy of the driver directly from peripheral device 14 during booting of computer 12, thereby substantially eliminating separately providing additional components, such as additional storage media, related to the driver.

In the illustrated embodiment, computer 12 comprises a processor 20, a memory 22, and a basic input/output system (BIOS) 24. The present invention also encompasses computer software that may be executed by processor 20. In the illustrated embodiment, memory 22 comprises an operating system 26, which is a computer software program. In FIG. 1, operating system 26 is illustrated as being stored in memory 22 where it may be executed by processor 20.

In the illustrated embodiment, system 10 also comprises a database 28 stored in memory 22. Database 28 comprises information associated with communicating with peripheral device 14. For example, in the illustrated embodiment, database 28 comprises a driver library 30. Driver library 30 comprises information associated with communicating with various types of peripheral devices 14. For example, driver library 30 may comprise a relational database associating a plurality of drivers with a variety of different types of peripheral devices 14. Driver library 30 may also comprise a generic driver 32 for providing basic communication dialog between computer 12 and various types of peripheral devices 14. For example, driver library 30 may comprise a generic driver 32 corresponding to various types and/or manufacturers of printers, scanners, or other types of peripheral devices 14 such that after determining a type of peripheral device 14 connected to computer 12, generic driver 32 may be used to initiate communications between computer 12 and the peripheral device 14.

In the illustrated embodiment, computer 12 also comprises an interface 40 for providing communications between computer 12 and peripheral device 14. In FIG. 1, interface 40 comprises a parallel port 42 and a serial port 44 to enable parallel and/or serial data communications, respectively, between computer 12 and peripheral device 14.

In the illustrated embodiment, peripheral device 14 comprises a processor 50 and a memory 52. Memory 52 comprises a read-only and/or read/write non-volatile memory. In the illustrated embodiment, peripheral device 14 also comprises an interface 54 for communicating with computer 12 via communication network 16. In FIG. 1, interface 54 comprises a parallel port 56 and a serial port 58 to enable parallel and/or serial communications, respectively, with computer 12.

In the illustrated embodiment, memory 52 comprises a driver 60 corresponding to peripheral device 14 to enable communications between computer 12 and peripheral device 14. For example, driver 60 comprises information associated with translating data and signals between computer 12 and peripheral device 14 based on the characteristics of peripheral device 14.

In operation, during startup or booting of computer 12, BIOS 24 uses interface 40 and communication networks 16 to determine the types of peripheral devices 14 coupled to computer 12. BIOS 24 may query or poll each peripheral device 14 coupled to computer 12 to ascertain a class and/or subclass of peripheral device 14 to determine a corresponding driver for the peripheral device 14. For example, BIOS 24 may select a particular driver stored in driver library 30 corresponding to a particular peripheral device 14 coupled to computer 12 based on information retrieved from the peripheral device 14 during booting of computer 12.

When driver library 30 does not contain a particular driver corresponding to the type of peripheral device 14 coupled to computer 12, BIOS 24 may designate generic driver 32 for initial communications with the particular peripheral device 14. For example, BIOS 24 may poll peripheral device 14 to ascertain a class and/or subclass of the type of peripheral device 14 for selecting a particular generic driver 32 from database 28. After ascertaining the class and/or subclass of peripheral device 14, an appropriate generic driver 32 may be selected from driver library 30.

After booting of computer 12, operating system 26 is activated or enabled to begin user operations corresponding to computer 12. In this embodiment, operating system 26 may also be adapted to poll peripheral device 14 to determine whether a driver corresponding to peripheral device 14 resides in memory 52. When driver 60 resides in memory 52 of peripheral device 14, a copy of driver 60 is transferred from peripheral device 14 to memory 22. For example, operating system 26 may initiate retrieval of a copy of driver 60 from memory 52 and store the copy of driver 60 in driver library 30. After downloading the copy of driver 60 from peripheral device 14, operating system 26 installs driver 60 and continues operations associated with peripheral device 14. For example, driver 60 may comprise a compressed file or other software structure that operating system 26 may extract or otherwise manipulate and install. When driver 60 does not reside in memory 52 of peripheral device 14, operating system 26 may prompt a user of system 10 to load or otherwise supply a driver corresponding to peripheral device 14.

As described above, peripheral device 14 may also accommodate transfer of a copy of a driver corresponding to peripheral device 14 from computer 12 to memory 52. For example, an updated driver corresponding to peripheral device 14 may reside in driver library 30 of computer 12. In operation, operating system 26 or BIOS 24 may poll peripheral device 14 to determine a version or release of driver 60 residing in memory 52 of peripheral device 14. If the driver residing in driver library 30 is an advanced version or release of driver 60, operating system 26 or BIOS 24 may automatically transfer a copy of the updated driver from driver library 30 into memory 52, thereby replacing driver 60 with a copy of an updated driver. Alternatively, peripheral device 14 may be adapted to automatically retrieve a copy of the updated driver from library 30. For example, peripheral device 14 may be adapted to poll library 30 for a listing of drivers available in library 30 and compare driver 60 with the drivers contained within library 30. In response to detecting an updated driver within library 30, processor 50 may automatically retrieve the updated driver from library 30.

In the example described above, operating system 26 polls peripheral device 14 to determine whether driver 60 resides in memory 52 of peripheral device. However, in another embodiment, system 10 may also be adapted such that BIOS 24 polls peripheral device 14 to determine whether driver 60 corresponding to peripheral device 14 resides in memory 52. For example, BIOS 24 may poll peripheral device 14 to ascertain a class and/or subclass of the type of peripheral device 14 to determine whether a driver corresponding to peripheral device 14 resides in driver library 30. When a driver corresponding to peripheral device 14 does not reside in driver library 30, BIOS 24 may use generic driver 32 corresponding to the class and/or subclass of peripheral device 14 to initiate communications with peripheral device 14. Using generic driver 32, BIOS 24 may then determine whether driver 60 corresponding to peripheral device 14 resides in memory 52 of peripheral device 14. When BIOS 24 determines that driver 60 does reside in memory 52 of peripheral device 14, BIOS 24 may initiate transfer of a copy of driver 60 from memory 52 to driver library 30.

As described above, operating system 26 or BIOS 24 may poll peripheral device 14 to determine whether driver 60 resides on peripheral device 14 and, when driver 60 resides on peripheral device 14, initiate a transfer of a copy of driver 60 from peripheral device 14. In another embodiment, peripheral device 14 may be adapted to automatically indicate that driver 60 resides on peripheral device 14 or automatically transfer a copy of driver 60 to computer 12 upon initiation of communications with computer 12. Thus, in this embodiment, processor 50 of peripheral device 14 may be adapted to initiate transfer of a copy of driver 60 to computer 12 in response to a communication connection to peripheral device 14 or in response to operating system 26 or BIOS 24 polling peripheral device 14 for driver 60. Peripheral device 14 may also be adapted to automatically identify driver 60 stored in memory 52 in response to a communication connection between peripheral device 14 and computer 12.

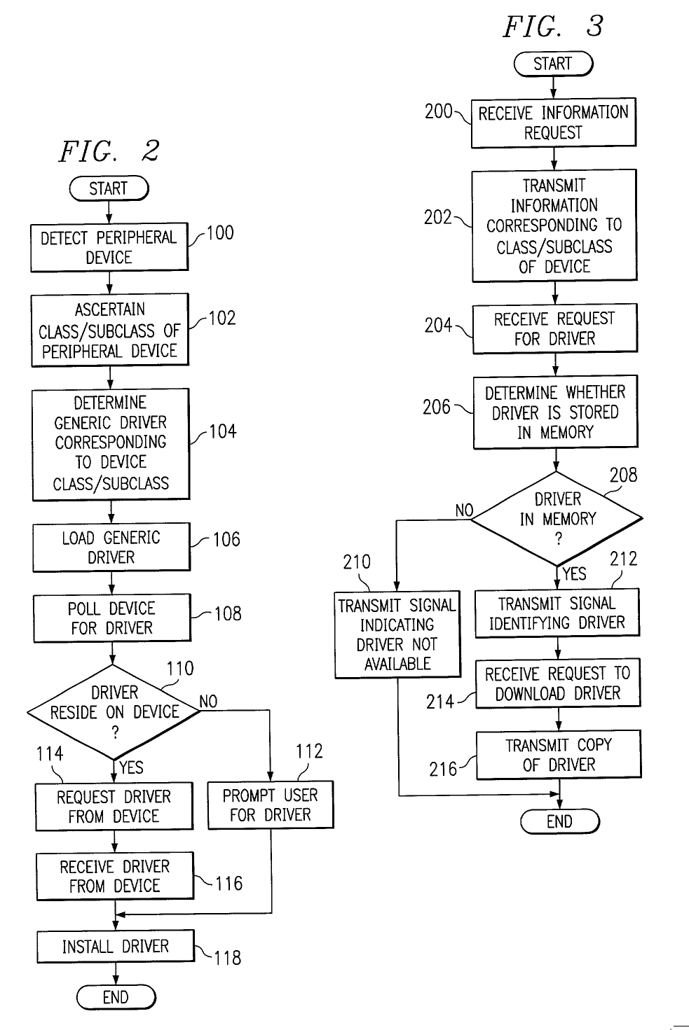

FIG. 2 is a flowchart illustrating a method for a device-resident driver system 10 in accordance with an embodiment of the present invention. The method begins at step 100, where BIOS 24 detects the presence of a peripheral device 14. At step 102, BIOS 24 ascertains a class and/or subclass of a type of peripheral device 14 coupled to computer 12. At step 104, BIOS 24 determines the generic driver 32 corresponding to the class and/or subclass of peripheral device 14. At step 106, the generic driver 32 is loaded to accommodate initial communications between computer 12 and peripheral device 14.

At step 108, operating system 26 polls peripheral device 14 to determine whether a driver corresponding to peripheral device 14 resides in a memory 52 of peripheral device 14. At decisional step 110, if driver 60 does not reside in memory 52 of peripheral device 14, the method proceeds from step 110 to step 112, where operating system 26 may prompt a user to load or otherwise supply a driver corresponding to the peripheral device 14. If driver 60 does reside in memory 52 of peripheral device 14, the method proceeds from step 110 to step 114, where operating system 26 requests a copy of driver 60 from peripheral device 14. At step 116, computer 12 receives a copy of driver 60 from peripheral device 14 and stores the copy of driver 60 in driver library 30. At step 118, processor 20 loads or installs driver 60 to accommodate continued communications between computer 12 and peripheral device 14.

FIG. 3 is a flowchart illustrating a method for device-resident driver installation in accordance with an embodiment of the present invention. The method begins at step 200, where peripheral device 14 receives an information request from computer 12. For example, the information request may comprise a request for a type of peripheral device 14 corresponding to a particular class and/or subclass of device. At step 202, peripheral device 14 transmits a response to the information request indicating the particular class and/or subclass of peripheral device 14.

At step 204, peripheral device 14 receives a request to determine whether driver 60 resides in memory 52 of peripheral device 14. At step 206, processor 50 determines whether driver 60 resides in memory 52. At decisional step 208, if driver 60 does not reside in memory 52, the method proceeds from step 208 to step 210, where a processor transmits a signal to computer 12 indicating that driver 60 is not available from peripheral device 14. If driver 60 resides in memory 52, the method proceeds from step 208 to step 212, where processor 50 transmits a signal to computer 12 identifying driver 60. At step 214, peripheral device 14 receives a request from computer 12 to transmit a copy of driver 60 to computer 12. At step 216, peripheral device 14 transmits a copy of driver 60 to computer 12 via communication network 16.

What is claimed is:

1. A peripheral device, comprising:
a memory; and
a driver stored in the memory and transferable to a computer, the driver adapted to interface the peripheral device with the computer.

2. The device of claim 1, wherein the peripheral device is adapted to automatically transmit the driver to the computer.

3. The device of claim 1, wherein the driver is retrievable from the memory by the computer.

4. The device of claim 1, wherein the memory is adapted to receive an updated driver from the computer.

5. The device of claim 1, wherein the peripheral device is adapted to retrieve an updated driver from the computer.

6. The device of claim 1, the peripheral device selected from the group consisting of a printer, a scanner, a mass storage device, a pointing device, a facsimile device, and a camera.

7. The device of claim 1, wherein the memory comprises read-only memory.

8. The device of claim 1, wherein the memory comprises a non-volatile memory.

9. The device of claim 1, wherein the peripheral device is adapted to compare the driver in the memory with a driver library of the computer.

10. The device of claim 1, wherein the peripheral device is adapted to automatically identify the driver to the computer.

11. A method for driver installation, comprising:
ascertaining a type of peripheral device;
determining whether a driver resides in a memory of the peripheral device; and
transferring a copy of the driver from the peripheral device if the driver resides in the memory of the peripheral device.

12. The method of claim 11, wherein ascertaining a type comprises determining a class of peripheral device.

13. The method of claim 11, wherein ascertaining a type comprises determining a subclass of the peripheral device.

14. The method of claim 11, further comprising installing the copy of the driver retrieved from the memory of the peripheral device.

15. The method of claim 11, further comprising determining whether the driver comprises an updated driver corresponding to the peripheral device.

16. The method of claim 11, further comprising replacing the driver in the memory of the peripheral device with an updated driver.

17. The method of claim 11, further comprising determining a generic driver corresponding to the type of the peripheral device.

18. The method of claim 17, wherein transferring comprises automatically receiving the copy of the driver from the peripheral device.

19. The method of claim 11, further comprising transmitting a copy of an updated driver to the peripheral device.

20. A computer system, comprising:
a memory accessible by a processor;
an operating system stored in the memory and accessible by the processor;
an interface adapted to communicate data between the operating system and a peripheral device; and
a basic input/output system (BIOS) adapted to retrieve a driver residing on the peripheral device.

21. The system of claim 20, further comprising a driver library comprising at least one generic driver adapted to communicate data between the operating system and the peripheral device.

22. The system of claim 20, wherein the operating system is adapted to determine whether an updated driver resides in the memory corresponding to the peripheral device.

23. The system of claim 22, wherein the processor is adapted to replace the driver residing on the peripheral device with a copy of the updated driver.

24. The system of claim 20, wherein the BIOS is adapted to ascertain a type of the peripheral device.

25. The system of claim 20, wherein the BIOS is adapted to ascertain a class corresponding to the peripheral device.

26. The system of claim 20, wherein the BIOS is adapted to ascertain a subclass corresponding to the peripheral device

27. The system of claim 20, wherein the processor is adapted to install the copy of the driver in the memory of the computer system.

28. The system of claim 20, the peripheral device selected from the group consisting of a printer, a scanner, a mass storage device, a pointing device, a facsimile device, and a camera.

29. A computer system, comprising:
means for detecting a peripheral device;
means for determining whether a driver for the peripheral device resides on the peripheral device; and
means for retrieving a copy of the driver from the peripheral device if the driver resides on the peripheral device.

30. The system of claim 29, further comprising means for determining whether an updated driver corresponding to the peripheral device resides in memory.

31. The system of claim 29, further comprising means for transferring a copy of an updated driver to the peripheral device.

32. The system of claim 29, further comprising means for locating a generic driver corresponding to the peripheral device.

33. The system of claim 29, further comprising means for ascertaining a type of the peripheral device.

34. The system of claim 29, the peripheral device selected from the group consisting of a printer, a scanner, a mass storage device, a pointing device, a facsimile device, and a camera.

35. The system of claim 29, further comprising means for ascertaining a class of the peripheral device.

36. The system of claim 29, further comprising means for ascertaining a subclass of the peripheral device.
